(19) United States
(12) Patent Application Publication
(10) Pub. No.: US 2012/0174068 A1
(43) Pub. Date: Jul. 5, 2012

(54) Testing Software Code

(75) Inventors: Michael Gutfleisch, Wiesloch (DE); Ekaterina Zavozina, Muehlhausen (DE); Klaus Ziegler, Neidenstien (DE)

(73) Assignee: SAP AG, Walldorf (DE)

(21) Appl. No.: 12/981,845

(22) Filed: Dec. 30, 2010

(51) Int. Cl. G06F 9/44

(52) U.S. Cl. 717/124

(57) ABSTRACT

A computer-implemented method for testing software code includes the following steps performed by one or more processors: receiving a request to test at least a first portion of software code at a test framework, where the first portion of software code includes a dependency on a second portion of software code; marking the second portion of software code to indicate the dependency in the first portion of code; and replacing the second portion of software code with a third portion of software code during testing of the first portion of software code based on the marking of the second portion of software code.

### TECHNICAL BACKGROUND

This disclosure relates to testing software code and, more particularly, to testing particular software code that includes one or more dependencies on separate software code.

### BACKGROUND

Software code, typically, is tested during and after development, as well as, for example, during development of upgrades to the code and other circumstances. Problems may often arise when testing code for a variety of reasons. For example, some software code that is to be tested (i.e., code under test (“CUT”)) often depends on other software code. This other code is often a component (e.g., production code to be shipped to a customer) on which the CUT depends, i.e., a depended on component, or “DOC.” These dependencies can often cause problems in testing the CUT. For instance, dependencies on objects or function modules may cause testing failures due to, for example, bugs in the objects or function modules themselves. As another example, dependencies on a database may cause testing problems (i.e., an inability to complete testing of the CUT) due to, for example, unexpected data in the database. Further, there may be unknown dependencies, which are required for the CUT to function (e.g., compile, execute or otherwise) correctly but which a developer is unaware.

Certain conventional techniques exist to help overcome these obstacles. For example, test doubles (“TD”), i.e., code that replaces a DOC and is only used for test purposes, may help enable testing of the CUT in isolation. As another example, dependency injection may be used. To make such CUT testable with these techniques, it may need to be reworked with high effort and risk due to changes in the production code. Thus, these techniques may not be attractive or available for many developers. Further, depending on, for example, the code language in which the CUT is written, such techniques may not fully overcome the aforementioned obstacles. Thus, additional techniques may be necessary to fully address these obstacles.

### SUMMARY

In one general embodiment, a computer-implemented method for testing software code includes the following steps performed by one or more processors: receiving a request to test at least a first portion of software code at a test framework, where the first portion of software code includes a dependency on a second portion of software code and, the request defines a test case to be executed at the test framework; marking the second portion of software code to indicate the dependency in the first portion of code; and replacing the second portion of software code with a third portion of software code during testing of the first portion of software code based on the marking of the second portion of software code.

In one or more specific aspects of this general embodiment, marking the second portion of software code to indicate the dependency in the first portion of code may include inserting one or more annotations in the first portion of software code.

In one or more specific aspects of this general embodiment, marking the second portion of software code to indicate the dependency in the first portion of code may include processing a selection of the second portion of software code in a development environment.

In one or more specific aspects of this general embodiment, marking the second portion of software code to indicate the dependency in the first portion of code may include processing at least one marker statement in the first portion of software code indicating the second portion of software code.

In one or more specific aspects of this general embodiment, replacing the third portion of software code in place of the second portion of software code during testing of the first portion of software code may include: identifying the third portion of software code based on a third statement in the software code indicating a beginning of the third portion of software code, which will be executed in place of the second portion of software code during testing of the first portion of software code; and processing a fourth statement in the software code indicating an end of the third portion of software code.

One or more specific aspects of this general embodiment may further include processing a second statement in the first portion of software code indicating an end of the second portion of software code.

In one or more specific aspects of this general embodiment, the second statement may include an endseam statement.

In one or more specific aspects of this general embodiment, the second portion of software code may include at least one of: a system field; an authority check; an object creation; a static method call; a file access; a function call; a database access; a data object; and a web service access.

In one or more specific aspects of this general embodiment, the first statement may include at least one of a marker or seam statement.

In one or more specific aspects of this general embodiment, the first portion of software code may include production code.

In one or more specific aspects of this general embodiment, the third portion of software code may include a first fragment of software code and a second fragment of software code. One or more specific aspects of this general embodiment may further include: replacing the second portion of software code with one or more of the first and second segments of software code during testing of the first portion of software code based on the marking of the second portion of software code.

In one or more specific aspects of this general embodiment, replacing the second portion of software code with one or more of the first and second segments of software code during testing of the first portion of software code based on the test case may include: determining one of the first segment or second segment of software code to replace the second portion of software code during testing of the first portion of software code based on the test case; and replacing the second portion of software code with the determined one of the first or second segments of software code during testing of the first portion of software.

In one or more specific aspects of this general embodiment, the second portion of software code may include a third fragment of software code and a fourth fragment of software code. One or more specific aspects of this general embodiment may further include: replacing one or more of the third and fourth fragments of software code with the third portion of software code during testing of the first portion of software code based on the test case.

In one or more specific aspects of this general embodiment, replacing one or more of the third and fourth fragments of software code with the third portion of software code during testing of the first portion of software code based on the test case may include: determining one of the third segment or fourth segment of software code to be replaced by the third portion of software code during testing of the first portion of software code based on the test case; and replacing the determined one of the third or fourth fragments of software code with the third portion of software code during testing of the first portion of software code.

In one or more specific aspects of this general embodiment, marking the second portion of software code to indicate the dependency in the first portion of code may further include specifying which of the third and fourth fragments of software code are to be replaced with the third portion of software code during testing of the first portion of software code.

In one or more specific aspects of this general embodiment, marking the second portion of software code to indicate the dependency in the first portion of code may further include triggering replacement of the second portion of software code with the third portion of software code during testing of the first portion of software code.

In one or more specific aspects of this general embodiment, the third statement may include at least one of: an inject statement; a call to an injection API; an inject annotation. In one or more specific aspects of this general embodiment, the third statement may also be expressed by meta data which is stored separately from the source code.

The present disclosure also provides a computer-readable, non-transitory storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes at least a server including one or more processors, and a computer-readable storage medium coupled to the one or more processors having instructions stored thereon which, when executed by the one or more processors, cause the one or more processors to perform operations in accordance with implementations of the methods provided herein.

Various embodiments of and including a software test framework using test seams may include one or more of the following features or advantages. For example, a software test framework, which supports testing with test seams, may be useful in testing both object-oriented code, as well as code written in non-object oriented languages. For example, the software test framework may replace statements, rather than, for example, objects and/or classes. In addition, the software test framework may be used for development languages that are not purely object-oriented but, for example, contain function module calls and statements which are provided by libraries in other languages. As another example, the software test framework may test a CUT while eliminating all or substantially all problem-causing dependencies with relatively few (e.g., about five statements) changes to the CUT. Further, the software test framework using test seams may test a CUT while eliminating all or substantially all problem-causing dependencies in both legacy and newly developed code. The software test framework using test seams may test a CUT while eliminating all or substantially all problem-causing dependencies without changing the functionality of the original code in the CUT. In addition, the software test framework using test seams may surround any kind of statement so as to eliminate and/or substantially eliminate dependencies such as, for example, SY-fields (e.g., system field), authority checks, database access, remote function calls (RFC), object creation, static methods, function modules, file access, and web service access. As another example, the software test framework using test seams may test a CUT while eliminating all or substantially all problem-causing dependencies.

These general and specific aspects may be implemented using a device, system or method, or any combinations of devices, systems, or methods. Put differently, while generally described as computer implemented software that provides for test seams of software code to be tested, some or all of the aspects may be computer implemented methods or further included in respective systems or other devices for performing this described functionality. The details of one or more implementations are set forth in the accompanying drawings and the description below. Other features, objects, and advantages will be apparent from the description and drawings, and from the claims.

### DESCRIPTION OF DRAWINGS

FIG. 1 illustrates one embodiment of a system for testing software code utilizing seam statements according to the present disclosure;

FIGS. 2A-2C illustrate examples of software code utilizing seam statements according to the present disclosure;

FIGS. 3A-3D illustrate examples of object-oriented software code utilizing seam statements according to the present disclosure;

FIGS. 4A-4B illustrate example methods for testing software code with a test framework using seam statements according to the present disclosure; and

FIGS. 5A-5B illustrate examples of software code in which one DOC is replaced with multiple portions of injected code in a test case according to the present disclosure.

### DETAILED DESCRIPTION

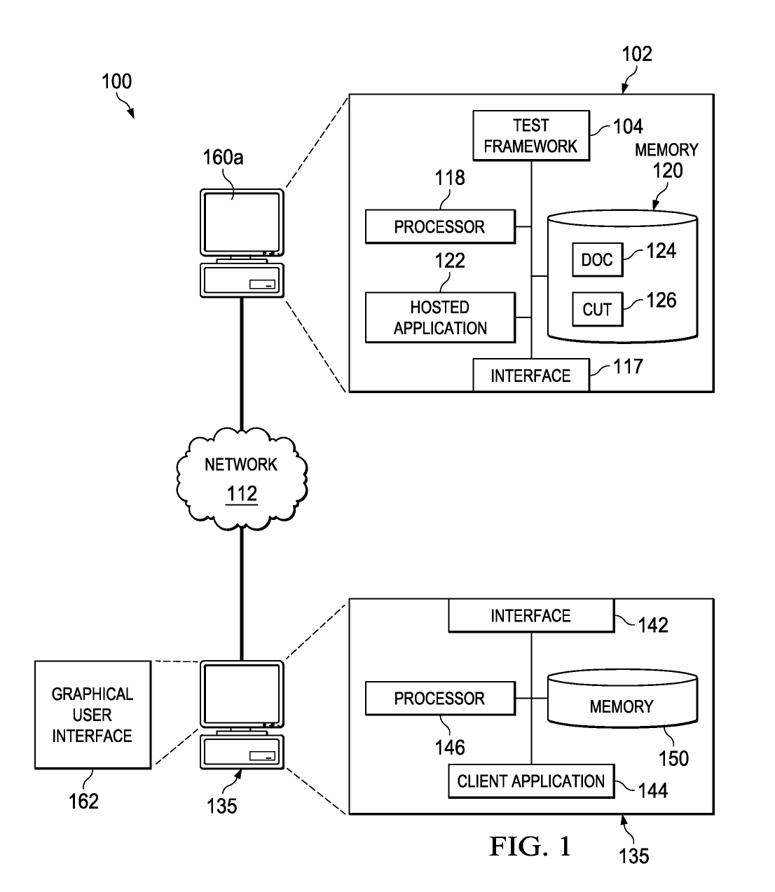

FIG. 1 illustrates an example environment 100 for testing software code (CUT) utilizing a software test framework and one or more test seams. The illustrated environment 100 includes or is communicably coupled with server 102 and one or more clients 135, at least some of which communicate across network 112. In general, environment 100 depicts an example configuration of a system capable of testing software code (CUT) utilizing a software test framework and one or more test seams. The environment 100 also supports one or more servers operable to provide a set of services to the client 135 or server 102 in which the one or more servers can be logically grouped and accessible within a cloud computing network. Accordingly, the unified runtime framework and graphical, process-centric user interface may be provided to a client 135 or server 102 as an on-demand solution through the cloud computing network or as a traditional server-client system. Further, the environment 100 also supports a Business Process Management Suite (BPMS) system operated by one or more web application servers. Different components of the BPMS system may be used to test CUT utilizing the software test framework and one or more test seams.

In general, server 102 is any server that stores one or more hosted applications 122, where at least a portion of the hosted applications 122 are executed via requests and responses sent to users or clients within and communicably coupled to the illustrated environment 100 of FIG. 1. For example, server 102 may be a Java 2 Platform, Enterprise Edition (J2EE)-compliant application server that includes Java technologies such as Enterprise JavaBeans (EJB), J2EE Connector Architecture (JCA), Java Messaging Service (JMS), Java Naming and Directory Interface (JNDI), and Java Database Connectivity (JDBC). In some instances, the server 102 may store a plurality of various hosted applications 122, while in other instances, the server 102 may be a dedicated server meant to store and execute only a single hosted application 122 or other applications. In some instances, the server 102 may comprise a web server or be communicably coupled with a web server, where the hosted applications 122 represent one or more web-based applications accessed and executed via network 112 by the clients 135 of the system to perform the programmed tasks or operations of the hosted application 122.

At a high level, the server 102 comprises an electronic computing device operable to receive, transmit, process, store, or manage data and information associated with the environment 100. The server 102 illustrated in FIG. 1 can be responsible for receiving application requests from one or more client applications 144 or business applications associated with the clients 135 of environment 100 and responding to the received requests by processing said requests in the associated hosted application 122, and sending the appropriate response from the hosted application 122 back to the requesting client application 144. Alternatively, the hosted application 122 at server 102 can be capable of processing and responding to local requests from a user accessing server 102 locally. Accordingly, in addition to requests from the external clients 135 illustrated in FIG. 1, requests associated with the hosted applications 122 may also be sent from internal users, external or third-party customers, other automated applications, as well as any other appropriate entities, individuals, systems, or computers. Further, the terms “client application” and “business application” may be used interchangeably as appropriate without departing from the scope of this disclosure.

As used in the present disclosure, the term “computer” is intended to encompass any suitable processing device. For example, although FIG. 1 illustrates a single server 102, environment 100 can be implemented using two or more servers 102, as well as computers other than servers, including a server pool. Indeed, server 102 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, illustrated server 102 may be adapted to execute any operating system, including Linux, UNIX, Windows, Mac OS, or any other suitable operating system. According to one embodiment, server 102 may also include or be communicably coupled with a mail server.

In the illustrated implementation, and as shown in FIG. 1, the server 102 includes a processor 118, an interface 117, a memory 120, and a software test framework 104. The interface 117 is used by the server 102 for communicating with other systems in a client-server or other distributed environment (including within environment 100) connected to the network 112 (e.g., client 135, as well as other systems communicably coupled to the network 112). Although FIG. 1 depicts a server-client environment, other implementations of the runtime environment for testing one or more CUT modules utilizing the test framework 104 and one or more test seams. For example, the runtime environment may be provided or accessed locally at a computer. Generally, the interface 117 comprises logic encoded in software and/or hardware in a suitable combination and operable to communicate with the network 112. More specifically, the interface 117 may comprise software supporting one or more communication protocols associated with communications such that the network 112 or interface's hardware is operable to communicate physical signals within and outside of the illustrated environment 100.

In some implementations, the server 102 may also include a user interface, such as a graphical user interface (GUI) 160a. The GUI 160a comprises a graphical user interface operable to, for example, allow the user of the server 102 to interface with at least a portion of the platform for any suitable purpose, such as creating, preparing, requesting, or analyzing data, as well as viewing and accessing source documents associated with business transactions. Generally, the GUI 160a provides the particular user with an efficient and user-friendly presentation of business data provided by or communicated within the system. The GUI 160a may comprise a plurality of customizable frames or views having interactive fields, pull-down lists, buttons, and other controls operated by the user. For example, GUI 160a may provide interactive elements that allow a user to enter or select elements of business process instances in GUI 160a. More generally, GUI 160a may also provide general interactive elements that allow a user to access and utilize various services and functions of hosted applications 122. The GUI 160a is often configurable, supports a combination of tables and graphs (bar, line, pie, status dials, etc.), and is able to build real-time portals, where tabs are delineated by key characteristics (e.g. site or micro-site). Therefore, the GUI 160a contemplates any suitable graphical user interface, such as a combination of a generic web browser, intelligent engine, and command line interface (CLI) that processes information in the platform and efficiently presents the results to the user visually.

Generally, example server 102 may be communicably coupled with a network 112 that facilitates wireless or wireline communications between the components of the environment 100 (i.e., between the server 102 and client 135 as well as between servers 140 and 102 or workstations 170), as well as with any other local or remote computer, such as additional clients, servers, or other devices communicably coupled to network 112 but not illustrated in FIG. 1. In the illustrated environment, the network 112 is depicted as a single network in FIG. 1, but may be comprised of more than one network without departing from the scope of this disclosure, so long as at least a portion of the network 112 may facilitate communications between senders and recipients. The network 112 may be all or a portion of an enterprise or secured network, while in another instance at least a portion of the network 112 may represent a connection to the Internet. In some instances, a portion of the network 112 may be a virtual private network (VPN), such as, for example, the connection between the client 135 and the server 102. Further, all or a portion of the network 112 can comprise either a wireline or wireless link. Example wireless links may include 802.11a/b/g/n, 802.20, WiMax, and/or any other appropriate wireless link. In other words, the network 112 encompasses any internal or external network, networks, sub-network, or combination thereof operable to facilitate communications between various computing components inside and outside the illustrated environment 100. The network 112 may communicate, for example, Internet Protocol (IP) packets, Frame Relay frames, Asynchronous Transfer Mode (ATM) cells, voice, video, data, and other suitable information between network addresses. The network 112 may also include one or more local area networks (LANs), radio access networks (RANs), metropolitan area networks (MANs), wide area networks (WANs), all or a portion of the Internet, and/or any other communication system or systems at one or more locations. The network 112, however, is not a required component of the present disclosure.

As illustrated in FIG. 1, server 102 includes a processor 118. Although illustrated as a single processor 118 in FIG. 1, two or more processors may be used according to particular needs, desires, or particular embodiments of environment 100. Each processor 118 may be a central processing unit (CPU), a blade, an application specific integrated circuit (ASIC), a field-programmable gate array (FPGA), or another suitable component. Generally, the processor 118 executes instructions and manipulates data to perform the operations of server 102 and, specifically, the one or more plurality of hosted applications 122. Specifically, the server's processor 118 executes the functionality required to receive and respond to requests from the clients 135 and their respective client applications 144, as well as the functionality required to perform the other operations of the hosted application 122.

Regardless of the particular implementation, “software” may include computer-readable instructions, firmware, wired or programmed hardware, or any combination thereof on a tangible medium operable when executed to perform at least the processes and operations described herein. Indeed, each software component may be fully or partially written or described in any appropriate computer language including C, C++, Java, Visual Basic, assembler, Perl, any suitable version of 4GL, as well as others. It will be understood that while portions of the software illustrated in FIG. 1 are shown as individual modules that implement the various features and functionality through various objects, methods, or other processes, the software may instead include a number of sub-modules, third party services, components, libraries, and such, as appropriate. Conversely, the features and functionality of various components can be combined into single components as appropriate. In the illustrated environment 100, processor 118 executes one or more hosted applications 122 on the server 102.

At a high level, each of the one or more hosted applications 122 is any application, program, module, process, or other software that may execute, change, delete, generate, or otherwise manage information according to the present disclosure, particularly in response to and in connection with one or more requests received from the illustrated clients 135 and their associated client applications 144. In certain cases, only one hosted application 122 may be located at a particular server 102. In others, a plurality of related and/or unrelated hosted applications 122 may be stored at a single server 102, or located across a plurality of other servers 102, as well. In certain cases, environment 100 may implement a composite hosted application 122. For example, portions of the composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's .NET, among others. Additionally, the hosted applications 122 may represent web-based applications accessed and executed by remote clients 135 or client applications 144 via the network 112 (e.g., through the Internet). Further, while illustrated as internal to server 102, one or more processes associated with a particular hosted application 122 may be stored, referenced, or executed remotely. For example, a portion of a particular hosted application 122 may be a web service associated with the application that is remotely called, while another portion of the hosted application 122 may be an interface object or agent bundled for processing at a remote client 135. Moreover, any or all of the hosted applications 122 may be a child or sub-module of another software module or enterprise application (not illustrated) without departing from the scope of this disclosure. Still further, portions of the hosted application 122 may be executed by a user working directly at server 102, as well as remotely at client 135.

As illustrated, processor 118 can also execute the software test framework 104 that may provide an environment and user interface for presenting to a user of client application 144 options for testing one or more portions of CUT, such as CUT 126 stored in memory 120. In some implementations, the software test framework 104 can be executed by a different processor or server external to server 102, such as by a server communicably coupled to server 102 through network 112. For example, the software test framework 104 may be provided as an on-demand service through a cloud computing network, as a web service accessible via network 112, or as a service provided on a dedicated server. The software test framework 104 can provide interfaces, modules, services, or metadata definitions that enable client application 144 to provide support for testing one or more portions of CUT 126 executed at server 102 or at a different server or workstation.

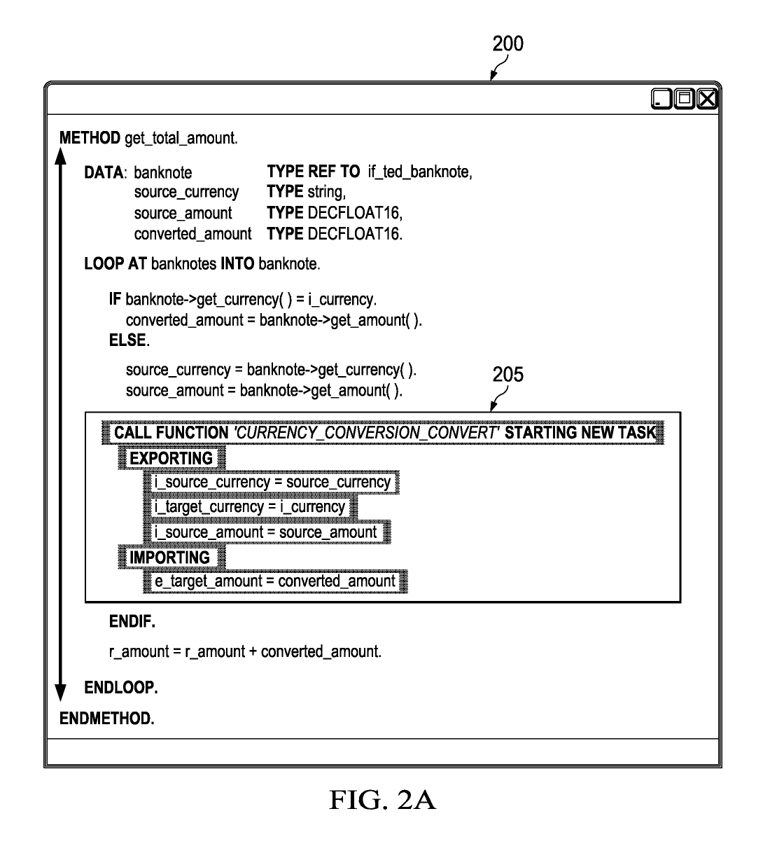

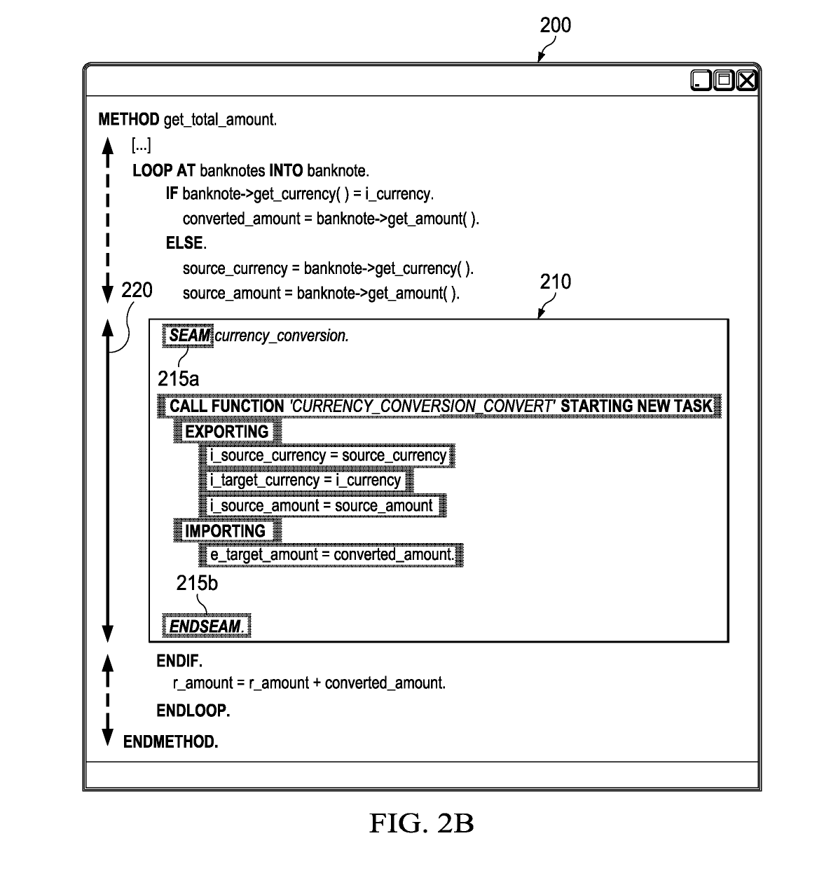

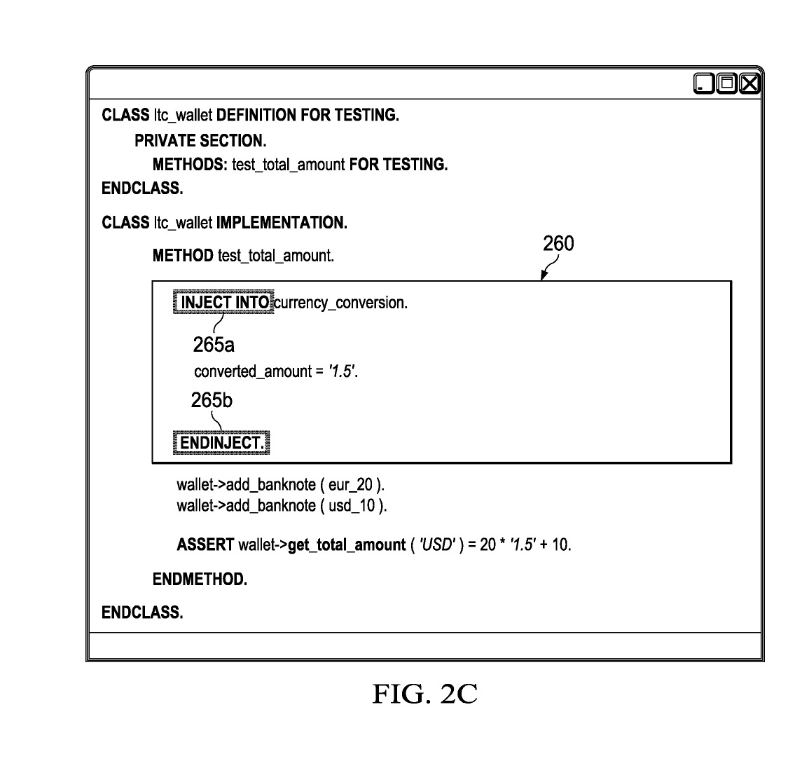

The software test framework 104, in some embodiments, may implement a systematic procedure to uncover defects at various stages of a development life cycle of CUT 126 or other software code to be tested. For example, the software test framework 104 provides various mechanisms for testing CUT 126 that includes one or more dependencies on other software code (depended on components, or DOC), such as DOC 124. These mechanisms are described in further detail below in connection with FIGS. 2-4 and generally include, for example, processing a test seam inserted into the CUT 126 to encapsulate a portion of software code that is not to be tested, and processing a replacement code portion (such as, for example, through one or more inject statements) that replaces the encapsulated portion of software code.

In general, the server 102 also includes memory 120 for storing data and program instructions. Memory 120 may include any memory or database module and may take the form of volatile or non-volatile memory including, without limitation, magnetic media, optical media, random access memory (RAM), read-only memory (ROM), removable media, or any other suitable local or remote memory component. Memory 120 may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the server 102 and its one or more hosted applications 122.

Memory 120 may also store data objects, for example, all or portions of software code, such as software code (CUT) 126 to be tested by the software test framework 104. CUT 126 may be objects, classes, methods, function modules, or other software code that may be required to be tested by the software test framework 104 prior to, for instance, delivery to a client, customer, or other entity. For example, the CUT 126 may be retrieved from memory 120 when the software test framework 104 is executed or initiated to test the CUT 126 for errors or other irregularities. Although illustrated as a single portion of software code, CUT 126 may be multiple portions of code to be tested, separate segments or modules of code to be tested in a single data file, or any other combination of modules, segments, portions, or other instances of code to be tested. Further, CUT 126 may be written in any programming language, such as, for example, C++, C, Java, ABAP (Advanced Business Application Programming by SAP), Visual Basic, assembler, Perl, any suitable version of 4GL, as well as others.

Memory 120 may also store one or more depended on components (DOC) 124. DOC 124 may be objects, classes, methods, function modules, data stored in one or more databases or other repositories, software code that are separate from or a part of the CUT 126, or other components on which the CUT 126 depends. The DOC 124 may be retrieved from memory 120 during testing of the CUT 126 by the software test framework 104. For example, the DOC 124 may be a particular function module within a method (i.e., the CUT 126). In some embodiments, the software test framework 104 may not be able to control the behavior of the DOC 124 during testing of the CUT 126. Thus, the CUT 126 (i.e., the method) may not be able to be tested at all.

The illustrated environment of FIG. 1 also includes one or more clients 135. Each client 135 may be any computing device operable to connect to or communicate with at least the server 102 and/or via the network 112 using a wireline or wireless connection. Further, as illustrated in FIG. 1, client 135 includes a processor 146, an interface 142, a graphical user interface (GUI) 162, a client application 144, and a memory 150. In general, client 135 comprises an electronic computer device operable to receive, transmit, process, and store any appropriate data associated with the environment 100 of FIG. 1. It will be understood that there may be any number of clients 135 associated with, or external to, environment 100. For example, while illustrated environment 100 includes one client 135, alternative implementations of environment 100 may include multiple clients communicably coupled to the server 102, or any other number of clients suitable to the purposes of the environment 100. Additionally, there may also be one or more additional clients 135 external to the illustrated portion of environment 100 that are capable of interacting with the environment 100 via the network 112. Further, the terms “client” and “user” may be used interchangeably as appropriate without departing from the scope of this disclosure. Moreover, while each client 135 is described in terms of being used by a single user, this disclosure contemplates that many users may use one computer, or that one user may use multiple computers.

The GUI 162 associated with client 135 comprises a graphical user interface operable to, for example, allow the user of client 135 to interface with at least a portion of the platform for any suitable purpose, such as creating, preparing, requesting, or analyzing data, as well as viewing and accessing source documents associated with business transactions. Generally, the GUI 162 provides the particular user with an efficient and user-friendly presentation of business data provided by or communicated within the system. The GUI 162 may comprise a plurality of customizable frames or views having interactive fields, pull-down lists, and buttons operated by the user. For example, GUI 162 may provide interactive elements that allow a user to enter or select elements of business process instances in GUI 162.

As used in this disclosure, client 135 is intended to encompass a personal computer, touch screen terminal, workstation, network computer, kiosk, wireless data port, smart phone, personal data assistant (PDA), one or more processors within these or other devices, or any other suitable processing device. For example, each client 135 may comprise a computer that includes an input device, such as a keypad, touch screen, mouse, or other device that can accept user information, and an output device that conveys information associated with the operation of the server 102 (and hosted application 122) or the client 135 itself, including digital data, visual information, the client application 144, or the GUI 162. Both the input and output device may include fixed or removable storage media such as a magnetic storage media, CD-ROM, or other suitable media to both receive input from and provide output to users of client 135 through the display, namely, the GUI 162.

The software test framework 104 (as well as the DOC 124 and CUT 126) may be presented and accessible to the user through GUI 162, such as through a web browser or other interface, for example. Thus, a developer utilizing client 135 and the GUI 162 may execute the test framework 104 on the server 102. Moreover, the present disclosure contemplates that the software test framework 104, as well as the DOC 124 and CUT 126, may be stored on and/or executable on the client 135. For example, all or portions of the DOC 124 and CUT 126 may be stored in memory 150. In some embodiments, all or portions of the DOC 124 may be stored separately from portions of the CUT 126; for instance, the DOC 124 may be stored in memory 120 while the CUT 126 may be stored in memory 150. Further, all or portions of the DOC 124 and CUT 126 may be stored in repositories separate from, but communicably coupled to, one or both of the server 102 and client 135.

While FIG. 1 is described as containing or being associated with a plurality of elements, not all elements illustrated within environment 100 of FIG. 1 may be utilized in each alternative implementation of the present disclosure. For example, although FIG. 1 depicts a server-client environment implementing a hosted application at server 102 that can be accessed by client computer 135, in some implementations, server 102 executes a local application that features an application UI accessible to a user directly utilizing GUI 160a. Further, although FIG. 1 depicts a server 102 external to network 112, servers may be included within the network 112 as part of a cloud network solution, for example. Additionally, one or more of the elements described herein may be located external to environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

FIGS. 2A-2C illustrate examples of software code utilizing seam statements. In some embodiments, seam statements inserted into a portion of software code, such as CUT 126 may isolate the CUT 126 from dependencies, such as DOC 124. In some embodiments, by isolating the DOC 124 from the CUT 126, the CUT 126 may be successfully tested by a software test framework, such as the software test framework 104. For example, by isolating the DOC 124 with one or more seam statements, the CUT 126 may be successfully tested by eliminating or partially eliminating dependencies in the CUT 126 (e.g., dependencies on function modules, data in databases or other repositories, and other dependencies).

Turning particularly to FIG. 2A, an example CUT 200 is illustrated. CUT 200 illustrates a method, specifically the method get_total_amount; this method may, for instance, calculate an overall amount of money converted into a certain target currency. CUT 200, as illustrated, includes a DOC 205, specifically, the function module CURRENCY_CONVERSION_CONVERT, which is called by the method get_total_amount. In some embodiments, a behavior of the DOC 205 (i.e., function module CURRENCY_CONVERSION_CONVERT) may not be controlled when testing the CUT 200 by a software test framework. Accordingly, the CUT 200 (indicated by the arrow) may not be able to be tested. While the function module of DOC 205 may be hidden behind an interface, thereby making it possible to replace the DOC 205 with a test double (e.g., a portion of code used only for test purposes), this may require major effort and risk to break the functionality of the method in the CUT 200.

Turning now to FIG. 2B, the CUT 200 is illustrated, including an isolated DOC 210. The isolated DOC 210 includes the DOC 205 bracketed with seam statements 215a and 215b. Seam statement 215a, in the illustrated embodiment, indicates a beginning of the isolated DOC 210 by the term “seam.” Seam statement 215b, in the illustrated embodiment, indicates an end of the isolated DOC 210 by the term “endseam.” The illustrated seam statements 215a-b define a seam 220 (indicated by the solid arrow)—specifically, the seam currency conversion. In some embodiments, the seam 220 may isolate the DOC 205 to form the isolated DOC 210, thereby allowing unisolated portions of the CUT 200 (e.g., shown by the dotted arrows) to be successfully tested by the software test framework. In some embodiments, the isolated DOC 210 is not tested during testing of the CUT 200, thereby eliminating or partially eliminating any problematic dependencies as described above.

Turning to FIG. 2C, in some embodiments, test-friendly code may be injected into the CUT 200 (illustrated in FIGS. 2A-B). FIG. 2C illustrates an example injection 260 that may be inserted into a portion of code, such as the CUT 200. In the illustrated embodiment, the injection 260 includes a begin inject statement 265a, indicated by the term “inject into,” and an end inject statement 265b, indicated by the term “end inject.” In the illustrated embodiment, one or more statements, or a block of statements, within the injection 260 may replace the content of a seam, such as the seam 220 illustrated in FIG. 2B. For example, in the illustrated embodiment, the injection 260 is an injection called currency conversion, which references the seam 220 shown in FIG. 2B. During testing of the CUT 200 by the software test framework (such as framework 104), the statements in injection 260 (specifically, converted_amount=‘1.5’) may be executed in place of the statements in the isolated DOC 210.

In some embodiments, statements inside the injection 260 may live inside the seam 220. Thus, in some embodiments, the scope of the injection 260 may be the scope of the processing block (e.g., method, function module, or otherwise) in which the seam 220 is defined. Further, in some embodiments, use of the seam 220 and/or the injection 260 may allow for the CUT 200 to be tested without changing the functionality of the CUT 200. Further, in some embodiments, seam 220 may be utilized to isolate any type of dependency defined in the DOC 205, such as, for example, SY-fields, Authority-Checks, Database Access, RFC calls, Object Creation, Static Methods, Function Modules, File Access, and other dependencies.

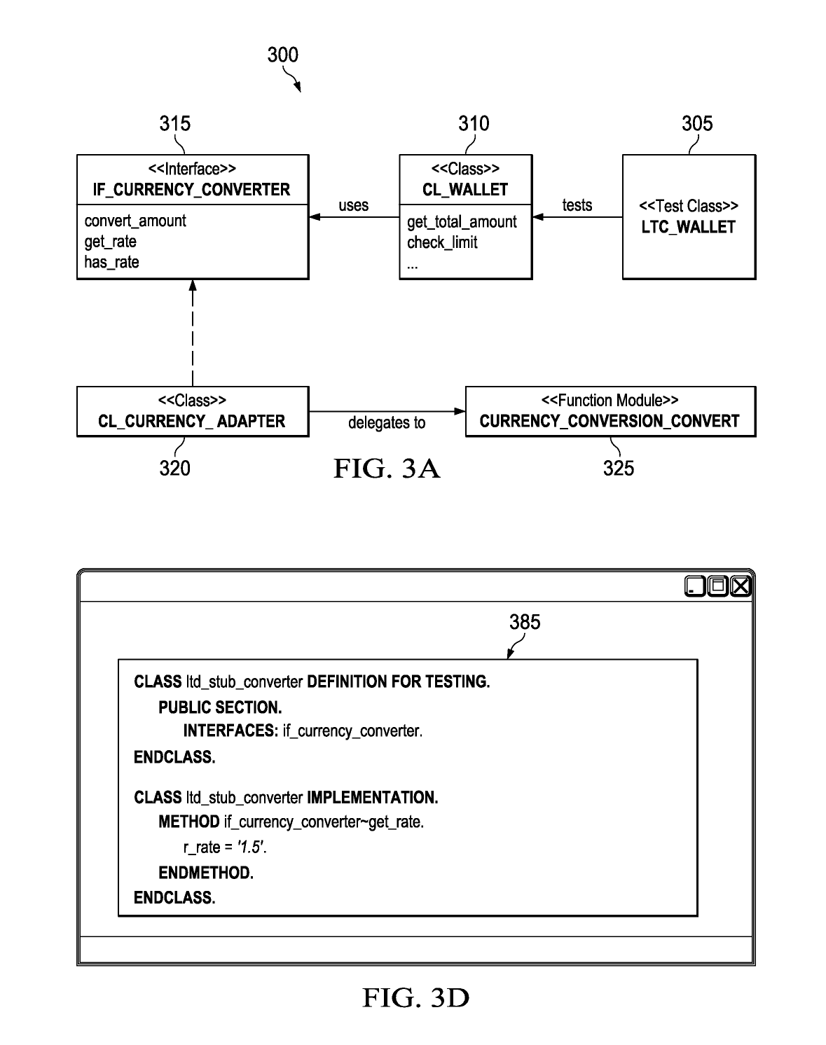

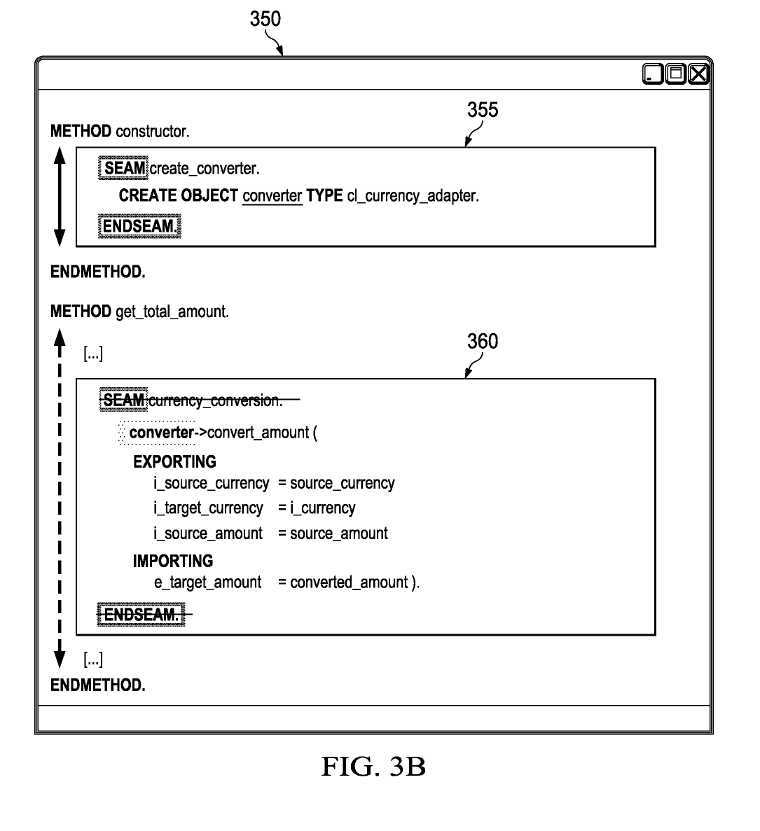

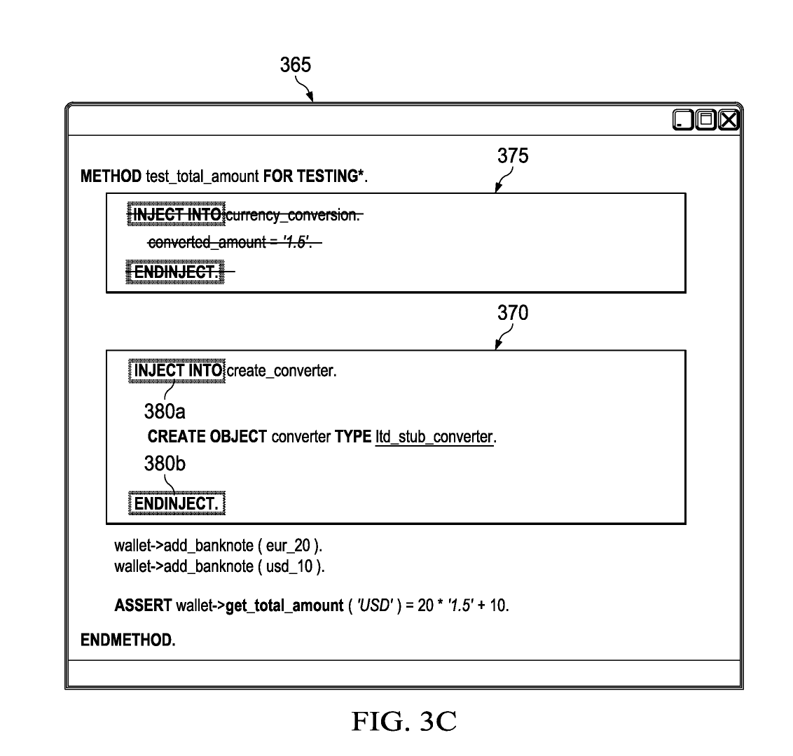

FIGS. 3A-3D illustrate examples of object-oriented software code utilizing seam statements. For example, in some embodiments, the techniques illustrated in FIGS. 2A-2C may be available to for testing legacy code, or code that is not written in a modern object-oriented approach or style. Alternatively, the techniques illustrated in FIGS. 2A-2C, in some embodiments, may be appropriately applied to code written in an object-oriented language. Further, the techniques described in FIGS. 3A-3D may also be applied for testing code, a CUT, developed in an object-oriented language. Turning to FIG. 3A, in particular, and continuing the previous example of currency conversion, an object-oriented map 300 is illustrated showing a test class 305 (representing the class LTC_WALLET), a class 310 (representing the class CL_WALLET), and an interface 315 (representing the interface IF_CURRENCY_CONVERTER). Map 300 also illustrates a class 320 (representing the class CL_CURRENCY_ADAPTER) and a function module 325 (representing the function CURRENCY_CONVERSION_CONVERT). As illustrated, the test class 305 tests the class 310, which uses the interface 315.

In some embodiments, the class 310 may be desired to be tested, i.e., may be a CUT to be tested by a software test framework such as framework 104. Further, it may be desirable to encapsulate function modules concerning currency conversion in the class 310 with a class and an interface (e.g., interface 315). Once encapsulated, and with the new interface and the new class in place, the CUT (i.e., the production code) may be changed. For example, the function module call may be replaced with a method call to the new interface. Turning to FIG. 3B, for example, this figure illustrates a CUT 350 including a seam 355. As illustrated, the CUT 350 (e.g., the class 310) includes a constructor that includes the seam 355. The seam 355, as shown in the illustrated embodiment, surrounds a converter, which, in some embodiments may make the converter replaceable for testing purposes (e.g., in order to test the CUT 350). As further illustrated in the CUT 350, an existing seam 360 may be removed. The existing seam 360, which may be identical or substantially similar to the seam 210 illustrated in FIG. 2B, surrounded and isolated the DOC 210. Now, with the inclusion of the seam 355, the existing seam 360 may not be needed anymore (e.g., moved from a call-seam to a creation-seam).

Turning now to FIG. 3C, this figure illustrates a test case 365 including an injection 370. The injection 370 may be test-friendly code injected into the CUT 350 (FIG. 3B) that replaces test-unfriendly code. In the illustrated embodiment, the injection 370 includes a begin inject statement 380a, indicated by the term “inject into,” and an end inject statement 380b, indicated by the term “end inject.” In the illustrated embodiment, the injection 370 implements the creation of an object “converter” of type ltd_stub_converter. In other words, the injection 370 implements a test stub (e.g., a test double that may be used to control information passed to a CUT) that may provide data and/or inputs into the CUT 350 to be tested. Turning briefly to FIG. 3D, for example, a stub 385 is illustrated. The stub 385 implements the statements to be called and/or executed during testing of the CUT 350 by a software test framework.

In some embodiments, the techniques described with reference to FIGS. 3A-3D may allow an entire method to be tested and have a seam in place which spans a single statement. Further, in some embodiments, these techniques may utilize a seam that is private by the nature of the CUT (e.g., CUT 350). In some embodiments, alternatively, a particular class to be tested, such as the wallet class in the example described above, may be public. For instance, the wallet class may depend on a currency conversion service as opposed to, for example, using data read from a database which contains rate information. As one example, the wallet class may depend on a web service provided by the New York stock exchange, or a risk-module which provides simulated rates, or some other currency conversion service. In such situations, a productive code, i.e., a CUT, may have a seam, which can be used by other classes.

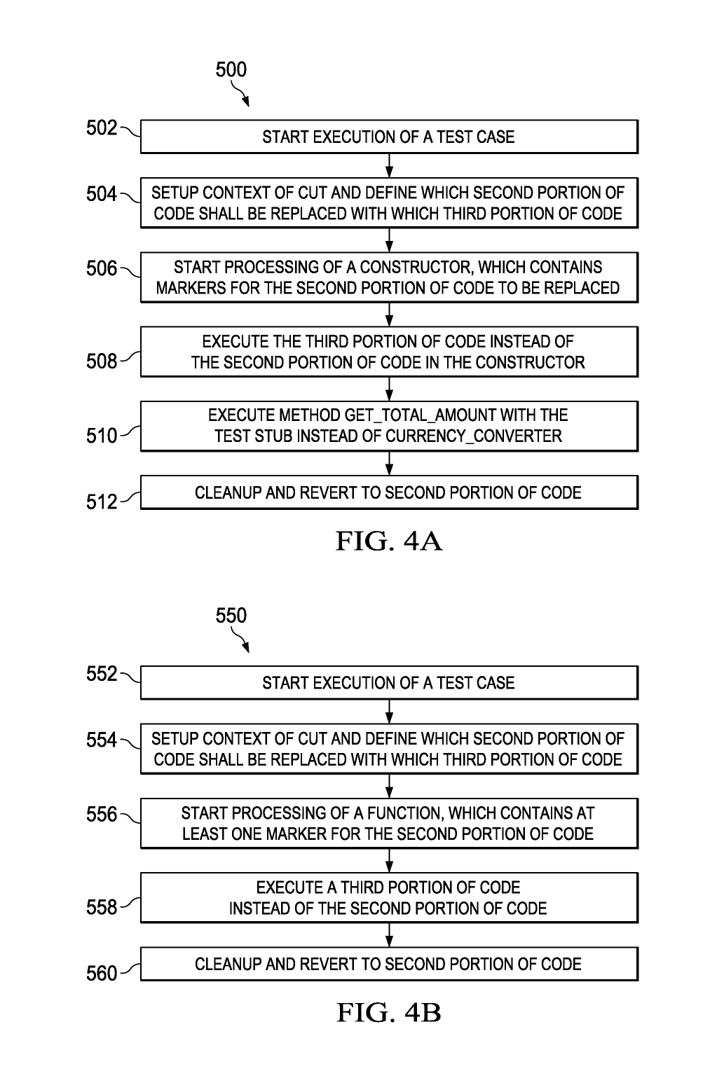

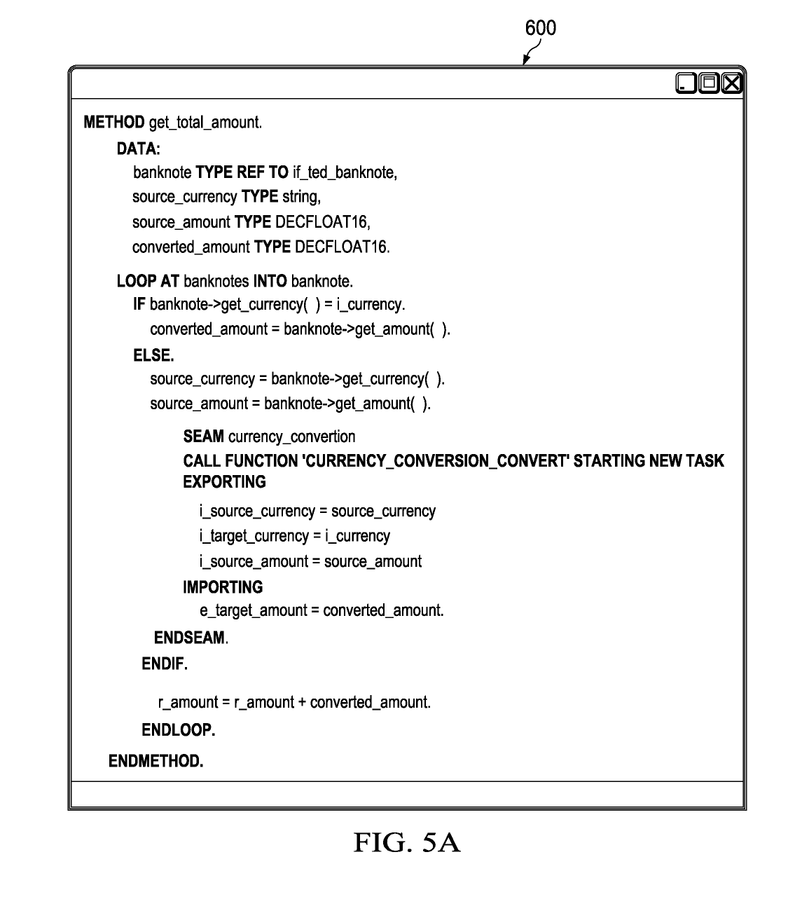

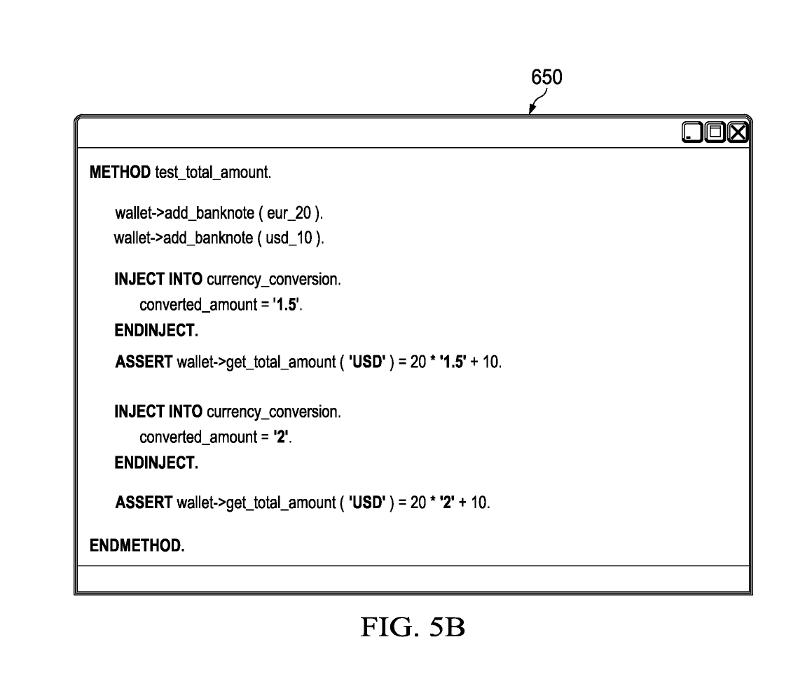

FIGS. 4A-4B illustrate example methods 500 and 550 for testing software code with a test framework using seam statements. Turning first to FIG. 4A and the illustrated method 500, this method may be used, for instance, when testing software code that is object-oriented code. A software test framework may start an execution of a test case at step 502. For example, the software test framework may be the framework 104, and the test case code may exercise the CUT 126, as illustrated in FIG. 1. Next at step 504, the framework may setup the context of CUT and define which third portion of code shall replace the second portion of code. The third portion of code, in some aspects, may be part of a test case (e.g., test code used to test other code) or a test double (e.g., code used for test purposes that replaces a DOC). Next, the framework may start the processing of a constructor, which contains at least one marker for the second portion of code to be replaced in step 506. The marker, in some embodiments, may be a seam statement as described above. The framework may then execute the third portion of code (e.g., injected code or a test stub) instead of the second portion of code in the constructor at step 508. Next, the framework may execute the CUT (e.g., a method such as the method get_total_amount shown in FIG. 5A below) with the test stub instead of the DOC (e.g., the currency_converter function module shown in FIG. 5A below) in step 510. For example, the test stub may be used to ensure that any broken or test-unfriendly dependencies on the second portion of code are avoided and/or replaced. Next, the test framework performs cleanup and reverts to the second portion of code (e.g., the DOC) at step 512. For example, in some embodiments, the test case, which framework executes may be a piece of code, meta data, or otherwise that describes which CUT should be executed with which parameters, and which results are expected. There may be, in some embodiments, four phases of the test case. First, there may be a preparatory phase, in which the replacement of the second portion of code with the third portion of code is performed. Next, there may be an execution phase, in which the CUT is invoked. Next, there may be a validation phase, in which the results of the CUT are validated. Finally, there may be a clean-up phase, in which the replacement of the second portion of code will be reverted. In some embodiments, therefore, the replacement of the second portion of code with the third portion of code occurs only during the test case execution.

Turning now to method 550 illustrated in FIG. 4B, this method may, in some aspects, be used for legacy (e.g., non object-oriented or partial object-oriented code). Alternatively, method 550 may also be used in testing of object-oriented code. A software test framework may start an execution of a test case at step 552. For example, the software test framework may be the framework 104, and the test case code may exercise the CUT 126. Next at step 554, the framework may setup the context of CUT and define a second portion of code (e.g., DOC 124) that shall be replaced with a third portion of code. The third portion of code, in some aspects, may be part of a test case (e.g., test code used to test other code) or a test double (e.g., code used for test purposes that replaces a DOC). Next, the framework may start processing a function, which contains at least one marker for the second portion of code, in step 556. The marker, in some embodiments, may be a seam statement as described above. The framework may then execute a third portion of code instead of the second portion of code at step 558. Next, the test framework performs cleanup and reverts to the second portion of code (e.g., the DOC) at step 560.

FIGS. 5A-5B illustrate an example of software code in which one DOC is replaced with multiple portions of injected code in a test case. FIG. 5A illustrates a CUT 600. As illustrated, the CUT 600 includes an implementation of a method called get_total_amount, which calculates an overall amount of money converted into a certain target currency. The method in CUT 600 includes a call to a function module called CURRENCY_CONVERSION_CONVERT. In the illustrated embodiment, the behavior of the function module CURRENCY_CONVERSION_CONVERT may not be able to be controlled by a test. Thus, in order to test the method get_total_amount, the function module call is marked using a seam statement. Thus, a test case may be defined, as illustrated in FIG. 5B.

FIG. 5B illustrates the test case 650, which, as illustrated, shows that one DOC (i.e., function module CURRENCY_CONVERSION_CONVERT) may be replaced during testing of CUT 600 with multiple injection code portions. For example, as illustrated, the method GET TOTAL AMOUNT may be tested using different currency conversion rates. First, converted_amount=1.5 may be injected in place of the function module CURRENCY_CONVERSION_CONVERT and the CUT 600 may be executed with its results validated. Next, converted_amount=2 may be injected in place of the function module CURRENCY_CONVERSION_CONVERT and the CUT 600 may be executed with its results validated. In other words, two (or more) different portions of injected code may replace the DOC inside of one test case.

During the execution of such test case, when the INJECT statement is processed, the replacement of the production code (i.e., the function module call or DOC) with the test code (converted_amount=1.5) may be triggered. During the next call of the CUT 600, the “injected” test code will be executed instead of the production code marked with the SEAM statement. When the next INJECT statement is processed, the first replacement will be reverted and the next one (converted_amount=2) may be “activated.” As an alternative example, a reference to the injected code may be used to inject the same portion in more than one test seam. Such injection in a test case may look like this: INJECT <name_of_injected_portion> INTO <name_of_SEAM>.

In addition, an injection in a test case may include other techniques alternative to the INJECT <name_of_injected_portion> INTO <name_of_SEAM> statement. For example, an injection can be triggered by a call to an application program interface (API), such as, for example: CL_API=>inject(name_of_injected_portion, name_of_SEAM). As another example, an injection can be triggered by an annotation, such as, for example: @INJECT(name_of_injected_portion, name_of_SEAM). Further, an injection may be made by meta data, i.e., content in a repository that may be used as a directive for a data-driven test framework to INJECT(name_of_injected_portion, name_of_SEAM).

A number of embodiments have been described. Nevertheless, it will be understood that various modifications may be made. For instance, the illustrated steps of methods 500 and 550 may be performed in different orders than those shown in FIGS. 4A-4B. Further, one or more of the illustrated steps of methods 500 and 550 may not be performed. One or more additional steps not illustrated herein may be implemented in some embodiments of methods 500 and 550. In addition, other methods related to the form transformation module according to the present disclosure may be implemented.

As another example, although illustrated in some portions of this disclosure as a single portion of software code, the DOC 124 (or other DOC) may consist of several, separate fragments of software code. Each segment, or fragment, of the DOC 124 may be treated separately. In other words, one or more of the fragments of the DOC 124 may be replaced during testing of the CUT 126. For example, a test framework may apply a test stub in place of the fragment of the DOC 124 during testing of the CUT 126. A determination of which fragment to replace may be made according to, for example, which fragment of the DOC 124 is more (or less) likely to cause a problem during exercising CUT 126 by a test case.

As yet another example, although illustrated in some portions of this disclosure as a single portion of software code, the injection 260 (or other injection) may consist of several, separate fragments of software code. Each segment, or fragment, of the injection 260 may be treated separately. In other words, one or more of the fragments of the injection 260 may be applied during testing of the CUT 126 in place of, for example, one or more portions of DOC 124. For example, a test framework may apply a particular fragment of the injection 260 during testing of the CUT 126. A determination of which fragment to apply may be made according to, for example, a test case. Accordingly, other embodiments are within the scope of the following claims.

What is claimed is:

1. A computer-implemented method for testing software code, the method comprising the following steps performed by one or more processors:
receiving a request to test at least a first portion of software code at a test framework, the first portion of software code comprising a dependency on a second portion of software code, the request defining a test case to be executed at the test framework;
marking the second portion of software code to indicate the dependency in the first portion of code; and
replacing the second portion of software code with a third portion of software code during testing of the first portion of software code based on the marking of the second portion of software code.

2. The method of claim 1, wherein marking the second portion of software code to indicate the dependency in the first portion of code comprises inserting one or more annotations in the first portion of software code.

3. The method of claim 1, wherein marking the second portion of software code to indicate the dependency in the first portion of code comprises processing a selection of the second portion of software code in a development environment.

4. The method of claim 1, wherein marking the second portion of software code to indicate the dependency in the first portion of code comprises processing at least one marker statement in the first portion of software code indicating the second portion of software code.

5. The method of claim 4, further comprising processing a second statement in the first portion of software code indicating an end of the second portion of software code.

6. The method of claim 5, wherein the second statement comprises an endseam statement.

7. The method of claim 5, wherein replacing the third portion of software code in place of the second portion of software code during testing of the first portion of software code comprises:
identifying the third portion of software code based on a third statement in the software code indicating a beginning of the third portion of software code;
executing the third portion of software code in place of the second portion of software code during testing of the first portion of software code; and
processing a fourth statement in the software code indicating an end of the third portion of software code.

8. The method of claim 7, wherein the third statement comprises at least one of:
an inject statement;
a call to an injection API;
an inject annotation; and
a portion of meta data defining an inject directive.

9. The method of claim 1, wherein the second portion of software code comprises at least one of:
a system field;
an authority check;
an object creation;
a static method call;
a file access;
a function call;
a database access;
a data object; and
a web service access.

10. The method of claim 1, wherein the first statement comprises a seam statement.

11. The method of claim 1, wherein the first portion of software code comprises production code.

12. The method of claim 1, wherein the third portion of software code comprises a first fragment of software code and a second fragment of software code, and the method further comprising:
replacing the second portion of software code with one or more of the first and second segments of software code during testing of the first portion of software code based on the test case.

13. The method of claim 12, wherein replacing the second portion of software code with one or more of the first and second segments of software code during testing of the first portion of software code based on the test case comprises:
determining one of the first segment or second segment of software code to replace the second portion of software code during testing of the first portion of software code based on the test case; and
replacing the second portion of software code with the determined one of the first or second segments of software code during testing of the first portion of software.

14. The method of claim 1, wherein the second portion of software code comprises a third fragment of software code and a fourth fragment of software code, and the method further comprising:
replacing one or more of the third and fourth fragments of software code with the third portion of software code during testing of the first portion of software code based on the test case.

15. The method of claim 14, wherein replacing one or more of the third and fourth fragments of software code with the third portion of software code during testing of the first portion of software code based on the test case comprises:
determining one of the third segment or fourth segment of software code to be replaced by the third portion of software code during testing of the first portion of software code based on the test case; and
replacing the determined one of the third or fourth fragments of software code with the third portion of software code during testing of the first portion of software code.

16. The method of claim 14, wherein marking the second portion of software code to indicate the dependency in the first portion of code further comprises specifying which of the third and fourth fragments of software code are to be replaced with the third portion of software code during testing of the first portion of software code.

17. The method of claim 1, further comprising triggering replacement of the second portion of software code with the third portion of software code during testing of the first portion of software code.

18. A computer program product tangibly embodied on a non-transient computer readable medium for testing software code, the computer program product storing instructions operable when executed by a hardware processor to perform operations comprising:
receiving a request to test at least a first portion of software code at a test framework, the first portion of software code comprising a dependency on a second portion of software code, the request defining a test case to be executed at the test framework;
marking the second portion of software code to indicate the dependency in the first portion of code; and
replacing the second portion of software code with a third portion of software code during testing of the first portion of software code based on the marking of the second portion of software code.

19. The computer program product of claim 18, wherein the operation of marking the second portion of software code to indicate the dependency in the first portion of code comprises at least one of:
inserting one or more annotations in the first portion of software code to mark the second portion of software code;
processing a selection of the second portion of software code in a development environment; or
processing at least one marker statement in the first portion of software code indicating a third portion of software code.

20. The computer program product of claim 18, wherein the operation of replacing the third portion of software code in place of the second portion of software code during testing of the first portion of software code comprises:
identifying the third portion of software code based on a third statement in the software code indicating a beginning of the third portion of software code;
executing the third portion of software code in place of the second portion of software code during testing of the first portion of software code; and
processing at least one marker statement in the first portion of software code indicating the second portion of software code.

21. The computer program product of claim 18, wherein the third portion of software code comprises a first fragment of software code and a second fragment of software code, and the operations further comprise:
replacing the second portion of software code with one or more of the first and second segments of software code during testing of the first portion of software code based on the test case.

22. The computer program product of claim 21, wherein the operation of replacing the second portion of software code with one or more of the first and second segments of software code during testing of the first portion of software code based on the test case comprises:
determining one of the first segment or second segment of software code to replace the second portion of software code during testing of the first portion of software code based on the test case; and
replacing the second portion of software code with the determined one of the first or second segments of software code during testing of the first portion of software.

23. The computer program product of claim 18, wherein the second portion of software code comprises a third fragment of software code and a fourth fragment of software code, and the operations further comprise:
replacing one or more of the third and fourth fragments of software code with the third portion of software code during testing of the first portion of software code based on the test case.

24. The computer program product of claim 23, wherein the operation of replacing one or more of the third and fourth fragments of software code with the third portion of software code during testing of the first portion of software code based on the test case comprises:
determining one of the third segment or fourth segment of software code to be replaced by the third portion of software code during testing of the first portion of software code based on the test case; and
replacing the determined one of the third or fourth fragments of software code with the third portion of software code during testing of the first portion of software code.

25. A system for testing software code, the system comprising:
a memory for storing instructions and one or more portions of software code; and
at least one hardware processor, the processor operable to execute the instructions to perform operations comprising:
receiving a request to test at least a first portion of software code at a test framework, the first portion of software code comprising a dependency on a second portion of software code, the request defining a test case to be executed at the test framework;
marking the second portion of software code to indicate the dependency in the first portion of code; and
replacing the second portion of software code with a third portion of software code during testing of the first portion of software code based on the marking of the second portion of software code.

26. The system of claim 25, wherein the operation of marking the second portion of software code to indicate the dependency in the first portion of code comprises at least one of:
inserting one or more annotations in the first portion of software code to mark the second portion of software code;
processing a selection of the second portion of software code in a development environment; or
processing at least one marker statement in the first portion of software code indicating the second portion of software code.

27. The system of claim 25, wherein the operation of replacing the third portion of software code in place of the second portion of software code during testing of the first portion of software code comprises:
identifying the third portion of software code based on a third statement in the software code indicating a beginning of the third portion of software code;
executing the third portion of software code in place of the second portion of software code during testing of the first portion of software code; and
processing a fourth statement in the software code indicating an end of the third portion of software code.

28. The system of claim 25, wherein the third portion of software code comprises a first fragment of software code and a second fragment of software code, and the operations further comprise:
replacing the second portion of software code with one or more of the first and second segments of software code during testing of the first portion of software code based on the test case.

29. The system of claim 28, wherein the operation of replacing the second portion of software code with one or more of the first and second segments of software code during testing of the first portion of software code based on the test case comprises:
determining one of the first segment or second segment of software code to replace the second portion of software code during testing of the first portion of software code based on the test case; and
replacing the second portion of software code with the determined one of the first or second segments of software code during testing of the first portion of software.

30. The system of claim 25, wherein the second portion of software code comprises a third fragment of software code and a fourth fragment of software code, and the operations further comprise:
replacing one or more of the third and fourth fragments of software code with the third portion of software code during testing of the first portion of software code based on the test case.

31. The system of claim 30, wherein the operation of replacing one or more of the third and fourth fragments of software code with the third portion of software code during testing of the first portion of software code based on the test case comprises:
determining one of the third segment or fourth segment of software code to be replaced by the third portion of software code during testing of the first portion of software code based on the test case; and
replacing the determined one of the third or fourth fragments of software code with the third portion of software code during testing of the first portion of software code.
